(19) United States
(12) Patent Application Publication
(10) Pub. No.: US 2004/0134753 A1
(43) Pub. Date: Jul. 15, 2004

(54) Half tray rotator

(75) Inventors: Glenn T. Diego, Newark Valley, NY (US); Lee J. Garigen, Attica, NY (US)

Correspondence Address: PERKINS, SMITH & COHEN LLP, ONE BEACON STREET, 30TH FLOOR, BOSTON, MA, 02108, US

(73) Assignee: Lockheed Martin Corp, a Maryland Corporation, Bethesda, MD

(21) Appl. No.: 10/341,712

(22) Filed: Jan. 14, 2003

(51) Int. Cl. B65G 43/08

(52) U.S. Cl. 198/395

(57) ABSTRACT

A tray turner for a conveying system which includes a conveyor for moving trays having hand openings on two opposite sides. A tray sensor detects whether the trays are properly oriented, and a turning station is located downstream from the tray sensor for turning those trays which are not properly oriented. The tray sensor detects the proper orientation by moving an arm along the adjacent side of the tray as it moves past the sensor to detect the hand opening and identify the half tray in an incorrect position. The turning section receives signals from the sensor and moves a tray rotator pin into the path of the nearest corner of a mis-aligned tray for momentarily intercepting such tray and moving it angularly 90 degrees into a position in which such tray is facing in the correct direction. The mis-aligned half trays abut against the rotator pin. There is a longitudinal guide immediately upstream from the tray rotator pin. A first stationary guide is located upstream from the longitudinal guide for moving all of the trays on the conveyor laterally as they move longitudinally along the conveying path so that they are aligned against the longitudinal guide, and thus into longitudinal alignment, as they move. There is a conveyor section immediately upstream from the tray detector and which includes the first stationary guide. The rollers of the conveying section are slightly canted in a direction to assist in moving the trays into alignment along the longitudinal guide. There is a second stationary guide downstream of the tray rotator pin to assist in the proper alignment and orientation of the tray.

### FIELD OF THE INVENTION

The present invention relates generally to the conveyor art, and, more particularly, to a conveyor turning station for turning articles, such as mail half trays, when they are not oriented properly.

### BACKGROUND OF THE INVENTION

In many types of conveying systems, articles, such as mail half trays, which are not oriented properly need to be turned in a very dependable and repeatable way, into the correct position. For example, in mail sorting systems, mis-oriented half trays can create jams in the equipment causing significant down time. Such mis-oriented trays will not have their covers properly placed and seated in the downstream equipment if the trays are mis-oriented and may lead to jams. Also, improperly oriented trays may not present the bar code labels to be read by bar code scanners.

U.S. Pat. No. 3,958,688 discloses a container turner for turning articles so that the same side always faces in the same direction after processing.

U.S. Pat. No. 4,085,839 discloses apparatus for conveying and turning articles having an obstacle in the conveying path which causes every article to have its position changed by being turned 90 degrees.

U.S. Pat. No. 4,784,493 relates to element recognition and orientation, and concerns mainly optical sensors without indicating how the orientation is to take place.

U.S. Pat. No. 4,369,873 discloses apparatus for laterally deflecting articles without rotating them.

U.S. Pat. No. 4,435,837 discloses a pattern recognition and orientation system.

U.S. Pat. No. 4,696,386 discloses a conveyor system diverter turn assembly using a belt drive for diverting articles from one conveyor to another. The articles are moved to a new line, and are not being reoriented on the same line.

U.S. Pat. No. 4,883,162 discloses a bag turning apparatus.

U.S. Pat. No. 5,325,972 discloses a method of controlling sorting systems, and a sorting system so controlled, and not with reorienting articles on a conveyor.

U.S. Pat. No. 5,823,317 discloses apparatus for reorienting articles while the articles are stopped from forward movement, and is a complicated mechanism.

U.S. Pat. No. 5,871,082 discloses an orientation parts feeder which acts upon all parts which enter the system and is not selective as to which articles are oriented.

U.S. Pat. No. 6,290,053 discloses an SMM (Half Tray) Tray Orientation Device in which trays, which have openings on two opposite sides, but not on their other sides, are turned 90 degrees when they are not properly aligned, using a biased hook and arm.

U.S. Pat. No. 6,419,074 discloses a 180 degree tray rotator which uses a pivoted arm located over a conveyor to move articles 180 degrees when they are not facing in a desired direction.

### SUMMARY OF THE INVENTION

A tray turner for a conveying system which includes a conveyor for moving trays having hand openings on two opposite sides. A tray sensor detects whether the trays are properly oriented, and a turning station is located downstream from the tray sensor for turning those trays which are not properly oriented. The tray sensor detects the proper orientation by moving an arm along the adjacent side of the tray as it moves past the sensor to detect the hand opening and identify the half tray in an incorrect position. The turning section receives signals from the sensor and moves a tray rotator pin into the path of the nearest corner of a mis-aligned tray for momentarily intercepting such tray and moving it angularly 90 degrees into a position in which such tray is facing in the correct direction. The mis-aligned half trays abut against the rotator pin. There is a longitudinal guide immediately upstream from the tray rotator pin. A first stationary guide is located upstream from the longitudinal guide for aligning all of the trays on the conveyor laterally as they move longitudinally along the conveying path so that they are aligned against the longitudinal guide, and thus into longitudinal alignment, as they move. There is a conveyor section immediately upstream from the tray detector and which includes the first stationary guide. The rollers of the conveying section are slightly canted in a direction to assist in moving the trays into alignment along the longitudinal guide. There is a second stationary guide downstream of the tray rotator pin to assist in the proper alignment and orientation of the tray.

Other objects, features and advantages will be apparent from the following detailed description of preferred embodiments taken in conjunction with the accompanying drawings in which:

### BRIEF DESCRIPTION OF THE DRAWINGS

FIG. 1 is an isometric view of the conveyor taken from above the conveyor at a downstream position with the stop pin shown in dashed lines.

FIG. 2 is an isometric view of the conveyor taken from below the conveyor at an upstream position and showing the stop pin mechanism.

FIG. 3 is an isometric view of the conveyor taken from slightly above the conveyor near the entrance to the conveyor section and showing an alignment guide as well as the sensor mechanism for sensing the presence of a tray handle hole and thus a tray.

FIG. 4 is an isometric view of the sensor mechanism.

FIG. 5 is a cross sectional view of the stop pin and part of its mechanism.

FIG. 6 is a diagrammatic plan view of the aligning and rotating sections in the conveyor line and showing the different positions taken by a mis-aligned tray.

FIG. 7 is an isometric view of a mail half tray showing the hand holes.

FIG. 8A is an isometric view of a skew roller plate, FIG. 8B is an isometric view of an outside washer for the drive roller, FIG. 8C is a side view of the outside washer for the drive roller, FIG. 8D is an isometric view of an inside washer for the drive roller, and FIG. 8E is a side view of the inside washer for the drive roller.

FIG. 9 is an isometric exploded view of the in-feed guide.

FIG. 10 is an isometric exploded view of the out-feed guide.

FIG. 11 is a schematic isometric view of the conveyor with the rollers removed and showing the roller axes.

### DETAILED DESCRIPTION OF THE DRAWINGS

The United States Postal Service (USPS) requires that postal trays and tubs, when conveyed into the auto-tray sleever (ATS), are in a particular orientation.

In the present invention the 90 degree tray rotator is designed to act selectively on objects passing through it, based on data supplied by a prior detection step. The objects can be letter mail trays, which generally are in two different sizes, and flat mail tubs, or other types of articles.

This device works on any similar objects, and could easily be scaled to process parcels or other objects of different size. In the present invention any half tray with hand holes on opposite sides which enters with the proper orientation is passed through without being acted upon by the rotator assembly.

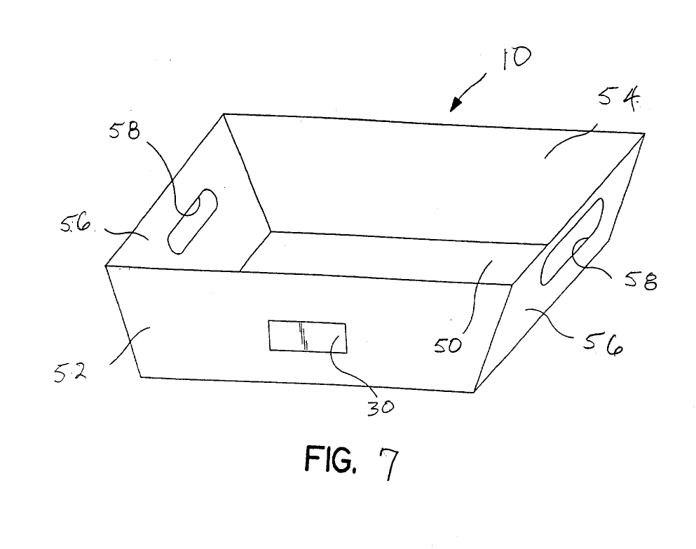

A typical half tray 10 is shown in FIG. 7 which shows the tray bottom 50 which, in one configuration is 12 inches by 14 inches originally. It has an inclined front wall 52 and an inclined back wall 54, both of which are 14 inches and on which there may be readable indicia 30 providing information about the destination of the tray. There are also inclined side walls 56 both of which are 12 inches and which have handles 58 formed by cut-out portions in each side wall. Typically the front and back walls are slightly wider than the side wall. The readable indicia is placed onto a label which is then attached to the front and/or back walls of the tray. The present invention takes advantage of this construction where the tray handles are unique to the sides of the tray, the front and back walls not having such handles. The tray detector is used in combination with the handles to detect mis-oriented half trays.

Should a tray have an incorrect orientation the tray rotator accomplishes a 90 degree rotation of the tray so that the tray has the proper orientation when the tray exits. This rotation is accomplished without any decrease in the forward velocity of the tray and therefore no decrease in conveyor processing capability. The rotation is accomplished, in one embodiment, through the use of a controlled solenoid actuated tray rotator pin which, when a tray requires rotation, is deployed by being moved into the path of a moving tray to affect an initial rotation of the tray. The tray then continues down the conveyor in its proper orientation. If a tray does not require rotation the solenoid is not deployed, and the tray passes through unaffected.

The figures show the present invention which reorients certain articles by rotating them by 90 degrees. It can be retrofitted into an existing conveyor line or constructed in a new conveyor line.

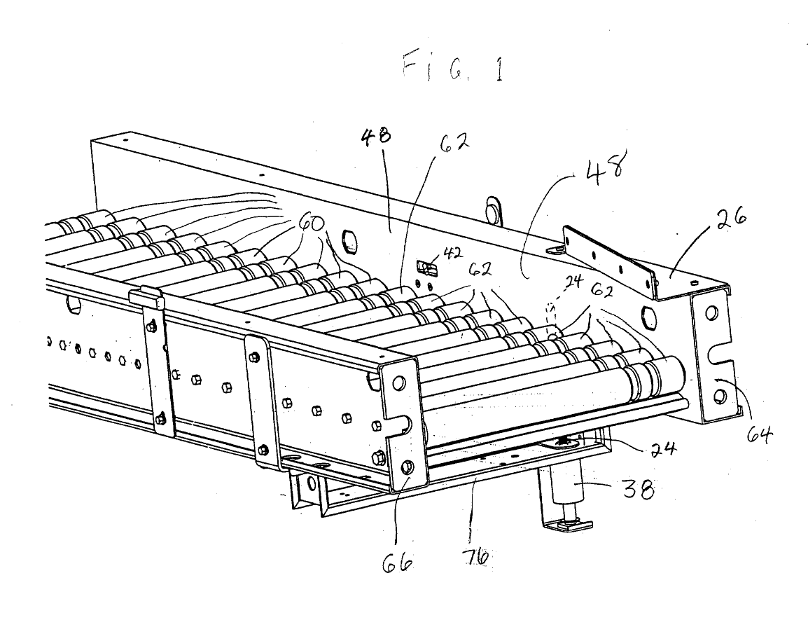

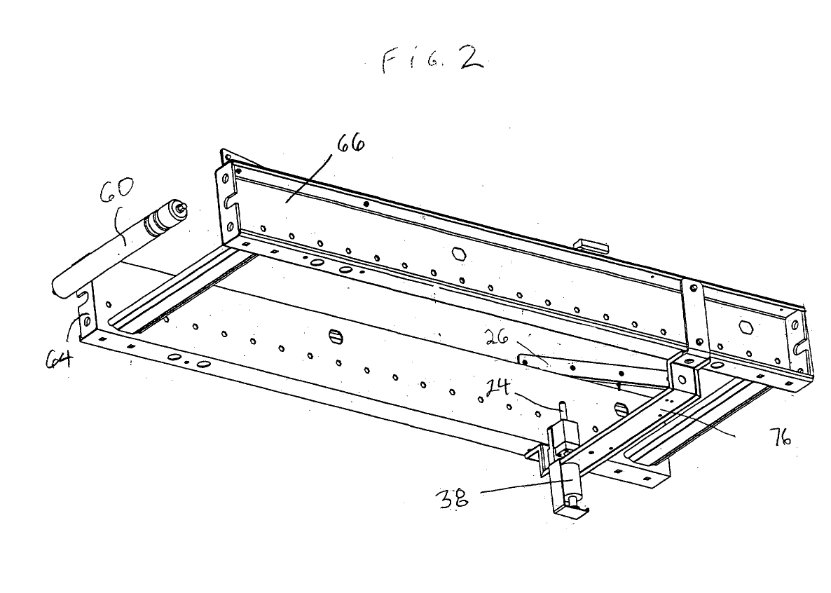

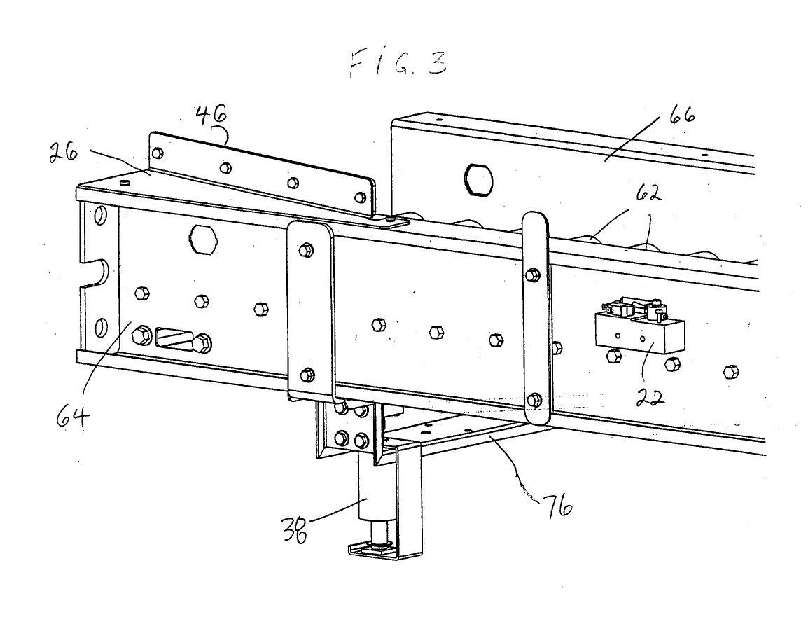

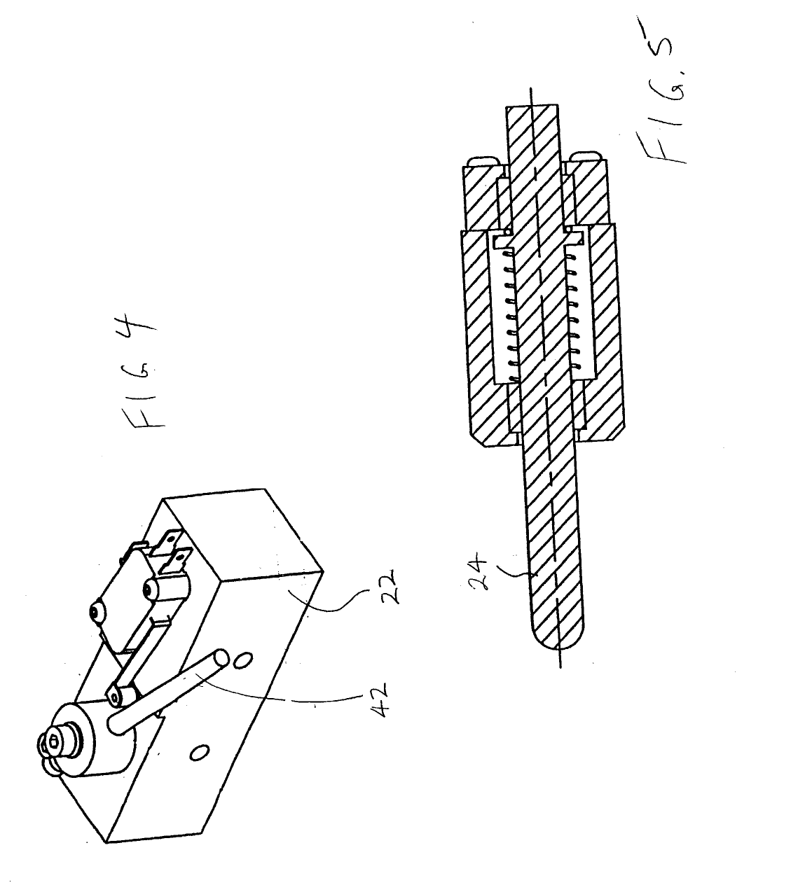

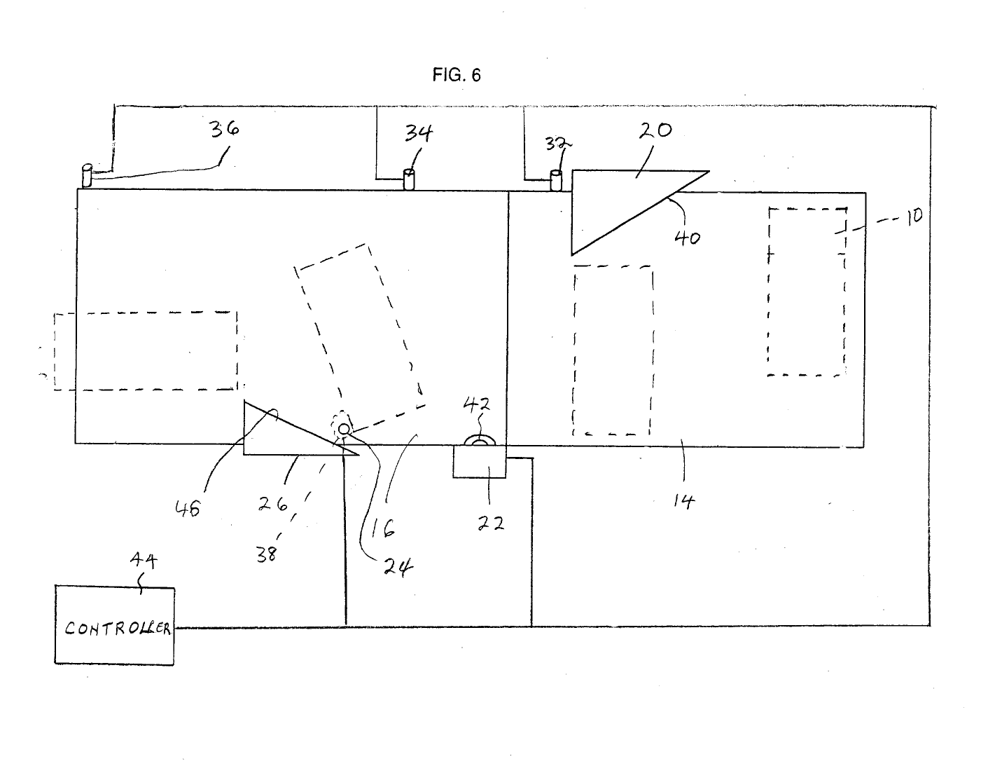

FIGS. 1 and 6 show the aligning section 14 and the turning section 16 and the multiple rollers 60 in the aligning section and rollers 62 in the turning section which form the conveyor. In this embodiment, each section has one drive roller and the other rollers are driven or idler rollers. There are, for example, 10 rollers 60 in the alignment conveyor section 14 and 10 rollers 62 in the turning conveyor section 16. One roller of each section is the drive roller and the other rollers are idler rollers. The idler rollers have spring mounted axles so they are easy to replace and move. The drive rollers are bolted in place. All of the rollers in a section are parallel to one another and are generally at right angles to the side supports. However, it should be noted that the aligning conveyor section 14 has its drive and idler rollers 60 slightly canted for a purpose which will be explained below.

The alignment conveyor section 14 and the turning conveyor section 16 may be connected by two side supports 64 and 66 each having a wall adjacent the conveyor rollers. The inner surface of side support 64 has a vertical alignment wall 48.

FIG. 6 shows the overall conveyor system sections of interest. Each section includes a plurality of rollers which, except for the aligning conveyor section 14, extend at right angles to the conveying direction and which form the conveying mechanism. Each section of rollers is driven independently of the other roller sections. The conveyor system includes an in-feed conveyor (not shown) which feeds the trays 10 to the aligning conveyor section 14 which prepares the trays for the 90 degree turn which is done in the following section, the turning conveyor section 16. As the trays 10 proceed along the conveyor after the necessary ones are turned, each tray reaches an out-feed conveyor section (not shown). When the present invention is retrofit into an existing conveyor line, the existing section upstream from the aligning section 14 is the in-feed section and the existing section downstream from the turning section 16 is the out-feed section.

There is an alignment guide 20 in the aligning conveyor section 14 which has an angled surface 40 which may have a teflon coating or outer layer. When the trays 10 move along the conveyor, if they are not aligned on the left side of the conveyor (with respect to the direction of travel) against wall 48 they abut the surface 40 of aligning guide 20 and are moved forwardly by the rollers 60 and also to the left, due to the canted mounting of the rollers 60 in section 14, as explained in more detail below, so that they become aligned along the left side of the conveyor against wall 48. As the trays 10 move along the conveyor they reach the beginning of turning conveyor section 16 and its rollers 62 and are sensed by a moving sensor arm 42 of half tray sensor 22.

This sensor 22 determines whether each tray is properly oriented by sensing whether or not a cutout handle 58 is adjacent wall 48. If it is, then the tray 10 is not properly aligned, and this information follows that tray so that when this tray approaches rotator pin 24, the pin control 38 is informed by controller 44 that this tray needs to be rotated by 90 degrees. If the particular tray being sensed by sensor 22 is one which is to be rotated, then pin 24 is moved by its driver 38 from its rest position below the conveying plane of the conveyors to a position above this plane so that the leading left corner of the tray 10 abuts the pin, as shown in FIG. 6. As this occurs the rollers 60 are continuing to move so that the tray 10 tries to move forward while its corner is temporarily stopped by the pin 24. This causes the right side of the tray to rotate because it continues to move forwardly. At a certain point the tray is rotated sufficiently that it is no longer stopped by the pin and the entire tray moves forwardly. There is an aligning element or out-feed guide 26 which the trays may contact on its angled surface 46, which may have a coating or layer of teflon 46A, as they move forwardly so that as the trays 10 enter and leave the turning conveyor section 16 the sides of the trays are parallel to the sides of the conveyor as shown by the position of tray 10 on section 16 in FIG. 6.

As the trays move through and past the two conveying sections, there are various sensors 32, 34 and 36 used to sense the position of each tray so that the controller always knows where each tray is located.

If the tray which is about to reach the position of the tray rotator pin station is one which is to be turned by 90 degrees, as determined by sensor 22, the pin mover 38, which may be a solenoid, is actuated which moves the tray rotator pin 24 from below the upper surfaces of the rollers 60 to a position above the upper surfaces of the rollers. When the corner of the tray reaches the raised tray rotator pin 24, which is spaced slightly from the alignment wall 48 of the conveyor, it is halted momentarily while the remainder of the tray continues to be moved forward by the rollers. This causes the tray to begin to turn in a counter clockwise direction while it is carried forward by the rollers. There is an outlet guide 26 having an angled surface 46, which may have a coating or layer of teflon 46A, and which moves the trays 10 toward the center of the conveyor as they leave the area of the abutment pin.

In this manner the tray rotator pin is used to begin the 90 degree turn of the trays which need to be turned.

The conveyor sections 14, 16 are formed by a series of parallel rollers 60, 62 all moving in the same direction in gangs by section and driven by drive rollers. Each section is independently driven so that each section may be independently stopped and move at different speeds, if desired. The controller 44 (which is known in the art) keeps track of the trays 10 and the sections and controls the operation. When a tray 10 which is to be turned is detected in the appropriate position for turning, the controller 44 activates the pin mover, which may be a solenoid, 38 to extend and move tray turning pin 24 longitudinally of its length near the side of the conveyor and thus rotates the tray to position. The tray then continues to be moved by the moving rollers 62 and continues its movement along the conveyor.

The tray rotator drive 38 and the rotator pin 24 may be supported on a bracket 76 below the rollers 62.

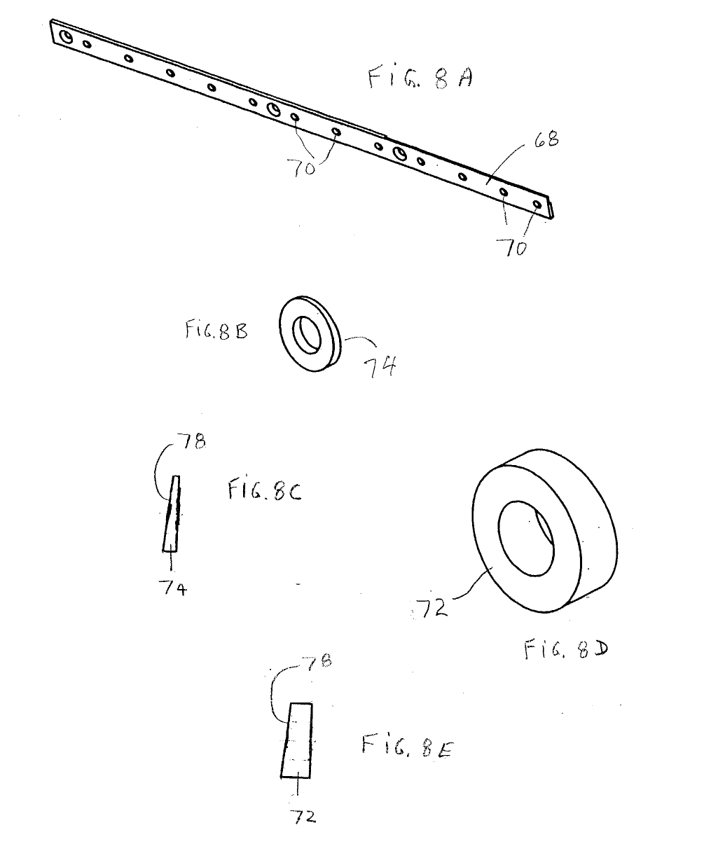

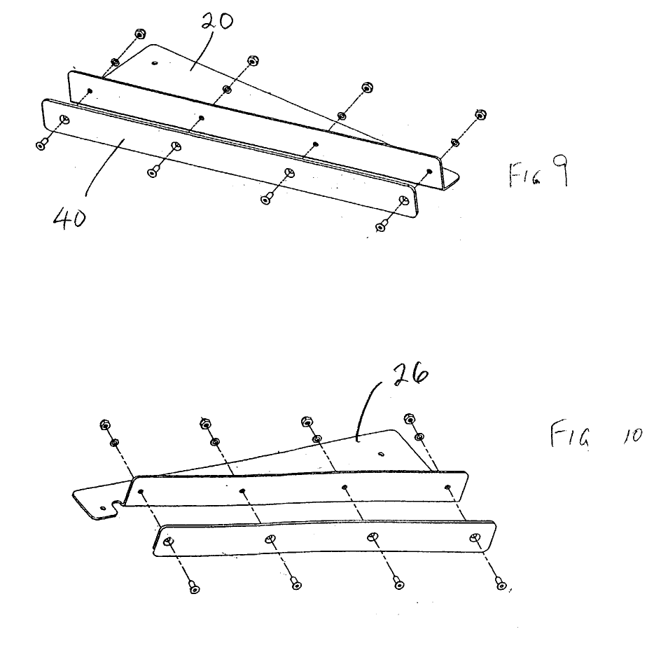

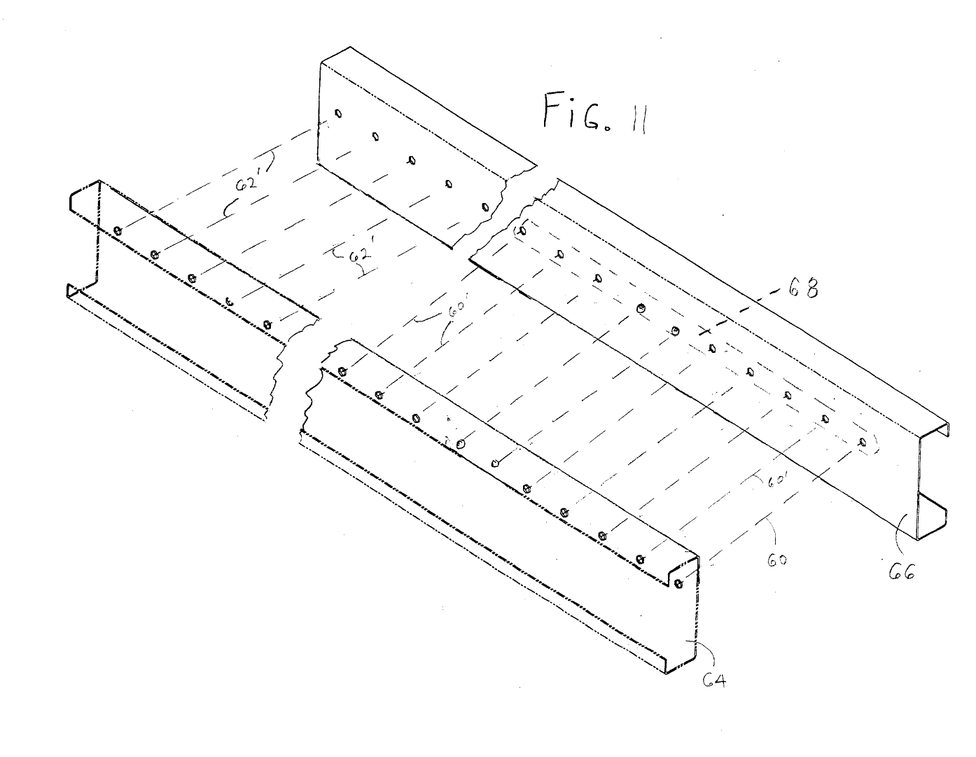

The idler rollers are mounted in openings in side supports 64 and 66. All of the rollers except rollers 60 are mounted to be at right angles with respect to the direction of movement of the trays 10. However, rollers 60 are mounted so they are slightly canted, the amount of cant being approximately one half the diameter of the rollers. On one side, e.g., the side of side support 66, the openings in which the rollers are mounted are moved by approximately one half the roller diameter in order to provide the canted rollers for canted driving of the trays when they are on the aligning conveyor section 14. This is shown in FIG. 11 where the axes of the rollers are shown and indicated as 60′ for rollers 60 and 62′ for rollers 62. This may be accomplished by using a mounting bar 68 (see FIG. 8A) along the inner wall of side support 66. This mounting bar 68 is shown in dashed lines in FIG. 11. There are openings 70 in the bar which are spaced apart the same distance as the opening in side support 64 but, by proper mounting of the bar, these opining are offset by approximately one half the diameter of the rollers.

In order to properly mount the drive roller, special washers, inside washer 72 and outside washer 74, are used which allow the canted mounting of the drive roller, but still permits the bolting of the roller firmly in place by providing flat surfaces 78 for this purpose. The washers have a different thickness from one end to the other as shown in FIGS. 8C and 8E.

Thus, only those trays which are improperly oriented have been turned by 90 degrees, and as they leave the turning section all half trays are oriented the same. Other types of trays proceeding on the conveyor will not be affected, since the present invention will only be acting on improperly oriented half trays.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

1. An article turning device for a conveying system which includes a conveyor for moving mail half trays along a longitudinal conveying path, comprising:
a. a longitudinal conveying path;
b. a detector for detecting whether a half tray moving along the longitudinal conveying path is in the correct orientation or needs to be turned; and
b. an article rotator pin downstream from the detector and arranged to receive signals from the detector for momentarily stopping the forward movement of a corner of the mis-oriented half trays which abut said pin and thereby move the half trays, which are in an incorrect orientation, angularly by 90 degrees and into the correct orientation along the longitudinal path.

2. A device as defined in claim 1 wherein said tray rotator pin is moved along its longitudinal axis into the path of the articles to rotate them out of their mis-oriented position.

3. A device as defined in claim 2 wherein the longitudinal axis of the pin is substantially perpendicular to the longitudinal conveying path.

4. A device as defined in claim 3 wherein said path, detector and rotator pin are constructed and arranged so that the article continues moving along the path even while it is being reoriented.

5. A conveying system for conveying mail trays, each having a bar code label, comprising:
a. a conveyor defining a longitudinal conveying path for moving mail trays;
b. a tray detector for detecting whether a tray moving along the conveyor is facing in an incorrect direction;
c. a longitudinal guide;
d. a first stationary guide upstream from said longitudinal guide for moving all of the trays on the conveyor laterally as they move longitudinally along the conveying path so they are aligned against said longitudinal guide and thus into longitudinal alignment as they move;
e. a turning station downstream from the tray detector for receiving signals from the detector for momentarily intercepting all trays which are determined by the detector to be facing in an incorrect direction, the turning station including a tray rotator pin which moves into a position where the corners of the trays facing in an incorrect direction abut the pin and cause the trays to begin a turning movement whereby the conveyor moves such mail trays angularly 90 degrees into their desired position.

6. A conveying system as defined in claim 5, further comprising an aligning conveyor section immediately upstream from the tray detector and which includes said first stationary guide, the rollers of said aligning conveyor section being slightly canted in a direction to assist in moving the articles into alignment along said longitudinal guide.

7. A device as defined in claim 6 wherein said tray rotator pin is moved along its longitudinal axis into the path of the articles in the vicinity of the longitudinal guide to rotate them out of their mis-oriented position by abuting of the trays with said pin.

8. A device as defined in claim 7 wherein the longitudinal axis of the pin is substantially perpendicular to the longitudinal conveying path.

9. A device as defined in claim 7 further comprising a second stationary guide downstream of said pin to assist in the proper alignment and orientation of the trays.

10. In a tray turning system for a conveying system which includes a conveyor for moving trays, which have hand openings on two opposite sides, along a longitudinal conveying path, a tray sensor for detecting whether the trays are properly oriented, and a turning station downstream from the tray sensor for turning those trays which are not properly oriented, the improvement comprising:
the tray sensor detecting the proper orientation by moving an arm along the adjacent side of the tray to detect such hand opening thereby identifying the half tray in an incorrect position, and
the turning section receiving signals from the sensor and moving an abutment into the path of the nearest corner of a mis-aligned tray for momentarily intercepting such tray and moving it angularly 90 degrees into a position in which such tray is facing in the correct direction.

11. The improvement as defined in claim 10 wherein said abutment is a tray rotator pin which is moved along its longitudinal axis and into the path of the trays to divert mis-oriented ones out of their mis-oriented position and into a properly oriented position.

12. The improvement as defined in claim 11 wherein the longitudinal axis of the tray rotator pin is substantially perpendicular to the longitudinal conveying path.

13. The improvement as defined in claim 12 further comprising a longitudinal guide immediately upstream from said tray rotator pin.

14. The improvement as defined in claim 13 further comprising a first stationary guide upstream from said longitudinal guide for assisting in moving all of the trays on the conveyor, which are not aligned against the longitudinal guide, laterally as they move longitudinally along the conveying path so they are aligned against said longitudinal guide and thus into longitudinal alignment as they move.

15. The improvement as defined in claim 14, further comprising an aligning conveyor section immediately upstream from the tray detector and including said first stationary guide, and the rollers of said aligning conveyor section being slightly canted in a direction to assist in moving the trays into alignment along said longitudinal guide.

16. The improvement as defined in claim 15, further comprising a second stationary guide downstream of said tray rotator pin to assist in the proper alignment and orientation of said tray.

17. The improvement as defined in claim 16 wherein said tray rotator pin is moved along its longitudinal axis into the path of the trays in the vicinity of the longitudinal guide to rotate them out of their mis-oriented position by abutting of the trays with said pin.

18. The improvement as defined in claim 17 wherein the longitudinal axis of the pin is substantially perpendicular to the longitudinal conveying path.
